(19) United States
(12) Patent Application Publication
(10) Pub. No.: US 2006/0274780 A1
(43) Pub. Date: Dec. 7, 2006

(54) Broadcast/multicast service signalling

(76) Inventors: Rod Walsh, Tampere (FI); Harri Hakulinen, Pirkkala (FI)

Correspondence Address: HARRINGTON & SMITH, LLP, 4 RESEARCH DRIVE, SHELTON, CT, 06484-6212, US

(21) Appl. No.: 10/551,879

(22) PCT Filed: Apr. 5, 2004
(86) PCT No.: PCT/IB04/01247

§ 371 Date: Sep. 30, 2005

(30) Foreign Application Priority Data
Apr. 3, 2003 (GB) 0307764.1

(51) Int. Cl. H04L 12/43

(52) U.S. Cl. 370/458; 370/508

(57) ABSTRACT

The invention relates to signalling in broadcast and multicast environments. For a service in the broadcast is defined an indicator, which is formulated into a unique indicator. The indicator is mapped into one time-slot in a signalling channel. A notification relating to the service is transmitted during the said time-slot. The notification is used for enabling the receiver for receiving said service, wherein the receiver may be turned off at other times.

### FIELD OF THE INVENTION

The invention relates to a method of creating signalling information relating to one or more available services in a network, and to a communications device comprising means for receiving signalling information on a signalling channel.

### BACKGROUND OF THE INVENTION

Point-to-point communication (p-t-p) involves two uniquely identified hosts, which may be devices and/or computers. This is sometimes also called unicast transmission. Point-to-point services can also be unidirectional such as a device specific message on a broadcast radio network. When discussing services we generally talk about the network service not the radio type (e.g. unicast, multicast and broadcast network services can all be provided to some extent by broadcast radio).

Broadcast is point-to-multipoint communication (p-t-m). The “point” is a unique source of service and the “multipoints” belong to a single uniquely identified “group”. So the p-t-m service inherently goes to multiple discrete receivers. These may be in the same radio cells (physical layer) or subnets (network layer) or spread across different ones. However, p-t-p services may end at a single point, but they may use multiple (downlink) paths to get there including more than one cell (e.g. a unidirectional point-to-point notification in 3G may go to all cells in a routing area when a UE is in idle-mode).

Generally, the multicast concept includes point-to-multipoint (e.g. IP radio), multipoint-to-multipoint (e.g. Voice over IP teleconference) and multipoint-to-point (e.g. some network services protocols) communications.

On the radio layer, the difference between p-t-p and p-t-m generally is that p-t-p is duplex (uplink+downlink) and p-t-m is simplex (downlink only). The difference between broadcast and multicast services (at radio/access level) is that broadcast does not use an uplink where as multicast may use an uplink on another (e.g. not shared) channel.

A user is not always interested in all the services that are transmitted by broadcast or multicast. Some of the transmitted services may have been subscribed or ordered by the user. Especially when the user device for receiving is a mobile device powered by batteries, the user may prefer to turn her device on (e.g. the radio interface powered up) only when the ordered or subscribed service is transmitted. The user terminal device may be controlled by using wakeup messages, which may be transmitted in a signalling or paging channel, which, in turn, may be different from the channels that the services are transmitted.

A 3G UE (user equipment=terminal) may be in one of three states: active, idle, and detached. Active is for normal user data communication, idle for conserving battery power and radio resources when user data is not transmitted, and detached for no connection (when network has no routing information about UE, e.g. when UE is switched off).

The combination of active and idle states gives the illusion of the UE having “always-on” connectivity to the PS (packet switched) network. This is accurate for “active”, but not the full picture for “idle”. In idle state, the UE and network have accurate routing information but are not able to transfer packets until active state is entered. The change from idle to active state can be initiated by either UE or network. For UE to network traffic initiation, the UE signals the network (including PDP context activation). For the network to UE traffic initiation the network “pages” the UE and when the UE “hears” the paging message it “wakes-up” and signals the network (including PDP context activation). The results of all the signalling is becoming “active” so that bearers are established throughout the network and radio link to deliver packets between UE and corresponding node (i.e. for point-to-point communication).

When the network has data for the UEs whose connection is in idle state, the network uses the paging channel to identify those UEs which should change to active state. If a UE “Listened” to the paging channel continuously it would use much battery power for mostly irrelevant data. To avoid this, each UE is assigned a repeated time-slot to listen for paging messages. These slots are repeated over a known interval (e.g. S seconds). To enable scalability (so the system works equally well when more UEs enter an area), the number of slots is defined and network and UEs use a simple hash function to calculate which slot contains signalling for which UEs (0, 1 or more UEs per slot).

Time-slicing or time multiplexing is a method of transmitting data in relatively short bursts using high bandwidth. The data comprising one or more services is combined and/or multiplexed and encapsulated prior to transmission. The bursts comprising the encapsulated data for the services may be transmitted periodically. The ideas of time-slicing are compatible with this invention and complement it. The bursts in time-slicing may comprise information on the next coming burst so that the receiver can be turned off between the bursts in order to save power.

In 3G systems, UEs are usually identified by IMSI for point-to-point services. 3GPP/MBMS is working on identification of point-to-multipoint (work-in-progress) but not (currently) for the application in this invention. MBMS is an acronym for Multimedia Broadcast/Multicast System. In DVB systems, UEs are usually identified by a MAC address for point-to-point and by MAC, and service_id (etc.) for point-to-multipoint. In IP systems, UEs are usually identified by IP address for point-to-point and by group (destination IP address), channel (destination and source IP address) or session id (e.g. SDP session id) for point-to-multipoint. The service identifier used for this invention could take on any of these formats for multicast/broadcast (point-to-multipoint) services identification, or a new format could be defined. It shall be noted that the user equipment in multicast applications described above usually implies the combined user equipment of the group of users.

The present systems have several drawbacks. Continuous listening even to the signalling channels wastes UE battery power, as the majority of data may be irrelevant for the user. Further deciding on timeslots and signalling this between network and UE can be complex, involve high signalling overhead and require some kind of robust delivery (due to lost packets on radio links). Also different “incoming data notifications” for broadcast and cellular systems means that more protocols have to be implemented, increasing total system (inc. UE) complexity as the user terminal devices are operable both in broadcast and cellular communication networks.

For identifying the user terminal, IMSI is used for point-to-point connections on 3G. Announcing the next slots of a certain “data channel” (one or more channel can contain signalling) using MPE MAC addressing is used in DVB-T. Further in DVB-T the SI information (e.g. INT table) may be used for signalling, but results in high signalling overhead, complex and a relatively un-dynamic way. DVB time-slicing with MAC addressing achieves a solution to some of this but suffers from complexity (more techniques must be added) and needs a robustness solution.

### SUMMARY OF THE INVENTION

According to a first aspect of the invention, there is provided a method of creating signalling information relating to one or more available services in a network, the method comprising the steps of: defining a service indicator for one or more of the services; formulating the service indicator into a unique indicator having a predetermined format; mapping the unique indicator into one time-slot of a signalling channel.

According to a second aspect of the invention, there is provided a communications device comprising: first receiving means for receiving broadcast transmissions comprising one or more services; second receiving means for receiving signalling information on a signalling channel; and means for controlling the first receiving means, wherein the first receiving means is enabled for receiving one or more services in the broadcast transmission upon received signalling information relating to said one or more services by the second receiving means.

Embodiments of the invention provide a novel concept, the MID (Multicast Identity). The MID identifies exact multicast services/streams on a multicast/broadcast network. In one embodiment a predefined hash function uses this identifier to calculate in which slot of a time-sliced channel data for that service will appear. Thus the UE (or other receiver terminal) can wake-up in that slot and save power at other times.

The data in that slot can be a service notification (like a paging message) which prompts the receiver terminal to open a connection to another channel—that may contain service data (e.g. video stream) or metadata (e.g. service announcement)

The application of some of the embodiments to point-to-multipoint multicast (where there are multiple UE recipients identified by the, shared, group identified) is relevant to both cellular and broadcast networks, for instance, specifically UMTS, GPRS, DVB-T. Furthermore, the application to point-to-point unicast is relevant to broadcast systems (e.g. DVB-T).

In 3G systems specifically for point-to-point unicast systems IMSI, TMSI or P-TMSI have been used, but the virtual identifiers according to some embodiments of the invention can be used in 3G systems.

One example of various MIDs is the case of an RTP session, which can be identified by multicast IP group address and destination UDP port. Another example is of an ALC session, which has channels uniquely identified by source and group IP addresses (S, G) and source and destination ports. Either of these examples could be IPv4 and IPv6.

Other examples could include MAC addressing (e.g. from IP mapping in RFC1112) and access network specific identification (such an IMSI).

The MID may be “borrowed” or calculated, i.e. it may be an explicit identifier which is used in announcements etc. such as a single IP address, or a value, which is the aggregate of others (e.g. the ALC channel parameters). Otherwise, it could be calculated as a single value, e.g. a mathematical function (e.g. a hash computation) could return the MID from the ALC channel parameters. In either case this may or may not involve messaging between the UE and network to share the MID.

In one embodiment the MID is shared by a plurality of users of a multicast group. The MID determines when announcements or other data relating to the multicast are transmitted (using a hash function to identify a time slot). In one embodiment, the MID is treated at the network side just like an IMSI.

The various embodiments can ensure power efficient and timely signalling to notify UEs of incoming messages, notifications and services. Multicast and broadcast data packets can now be signalled in different communication systems, which the user device is connectable to.

The embodiments provide simple ways to synchronize signalling time slots between UE and network on broadcast (e.g. DVB-T) networks where repeated slots automatically provide robust delivery. Further the embodiments provide low signalling overhead in communications.

Practically zero radio resources are used to find the signalling slot.

One advantage is that the incoming data notification for broadcast and cellular systems are compatible due to similar approach for point-to-point and point-to-multipoint, and also cellular and broadcast.

The invention will now be described, by way of example, with reference to the drawings.

### BRIEF DESCRIPTION OF THE DRAWINGS

In the drawings:

FIG. 1 is a general overview of a broadcasting system according to one embodiment of the invention,

FIG. 2 illustrates the time diagram for the broadcast stream, the signalling channel and the user device on/off in one embodiment of the invention,

FIG. 3 shows one embodiment of the invention, where a cell identification is used in the hash function,

FIG. 4 illustrates the process of forming the MID and allocating a time slot for it according to one of embodiment, and

FIG. 5 illustrates an embodiment of the user device.

### DETAILED DESCRIPTION OF THE EMBODIMENTS

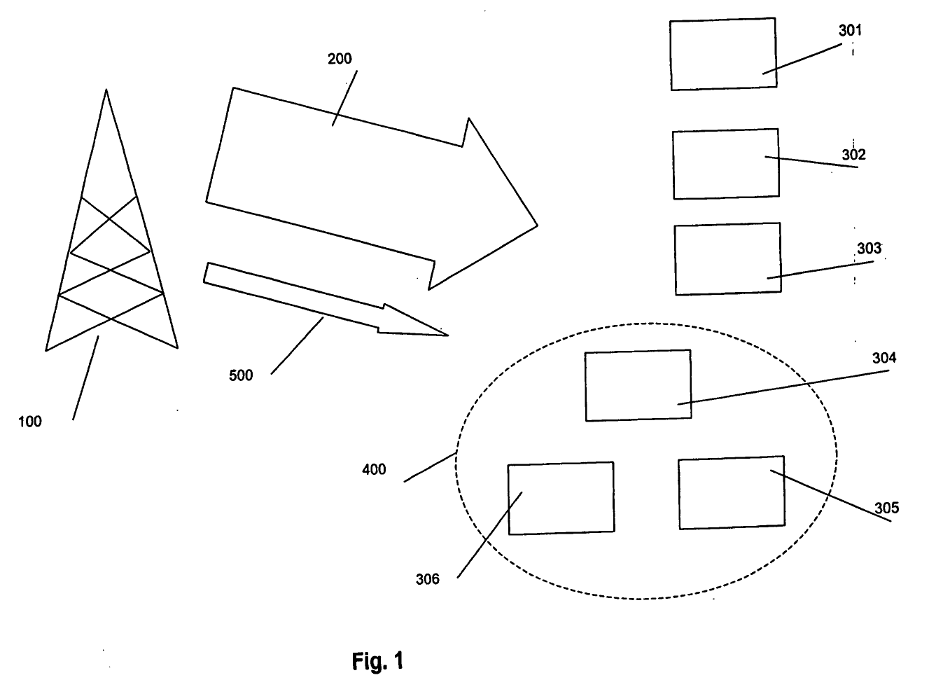

One embodiment is illustrated in FIG. 1, where the broadcaster is referred with reference number 100. The broadcaster is transmitting a broadcast stream 200 comprising a plurality of services. Some of the transmitted services can be received and consumed by any user terminal 301-306 but the broadcast stream 200 may comprise also services that the user of the terminal has subscribed or ordered. The broadcaster 100 is also transmitting signalling information 500, which is associated to the broadcast stream 200. The signalling information 500 may be transmitted by using a separate signalling channel. Some of the user terminals 304-306, which have subscribed the same service may form a group 400.

The user terminals 301-306 are associated with one or more unique MIDs. In addition to this the user terminals 304-306 forming the group 400 have one or more MIDs in common.

Although in FIG. 1 is shown only one broadcaster, there may be several broadcasters each transmitting one or more broadcast streams. The broadcasted streams may comprise DVB transmissions, DAB transmissions, IP datacasting transmissions, or combinations of them and other types of transmissions, The broadcasted stream may also comprise time-slicing-type of transmissions.

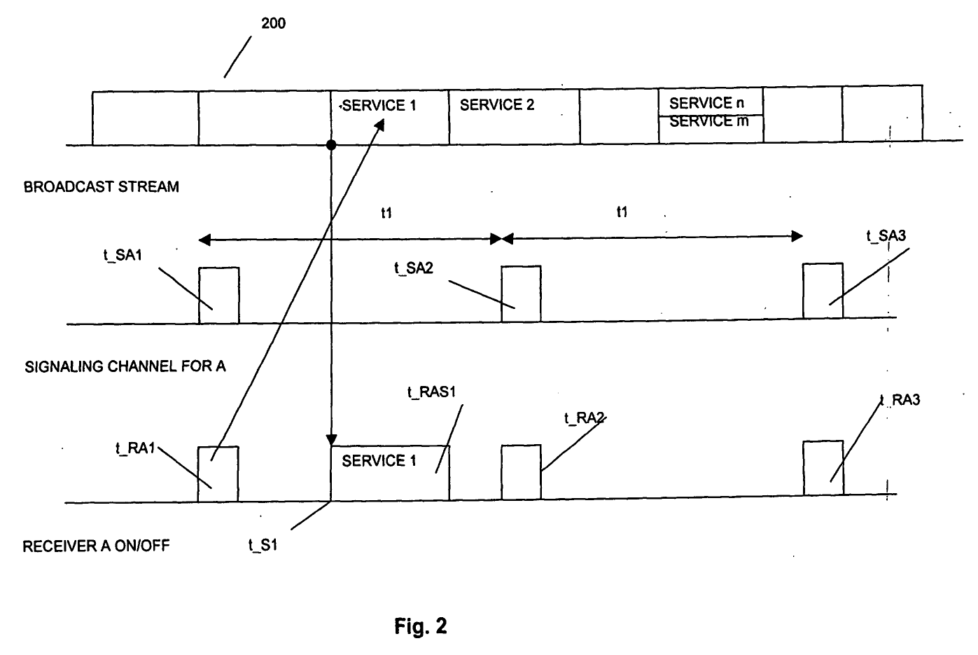

In FIG. 2 the broadcast stream 200 comprises a plurality of services, which are transmitted sequentially in the broadcast channel. The signalling information 500 is in this example is transmitted periodically in the signalling channel. In this example the signalling information 500 is transmitted during time-slots of which only three: t_SA1, t_SA2, and t_SA3 are shown. The time-slots are transmitted with a period of t1. In the illustrated example the user device or receiver 301 is on for time-slots t_RA1, . . . , t_RA3 for receiving signalling information. It is assumed that in this example during t_SA1 the user device 301 receives a notification that a user subscribed service, SERVICE 1, will be transmitted starting at time t_s1. The user device 301 will be turned on at that time, provided that the user accepts it or has accepted it in advance. The user device 301 will then be on during t_RAS1 and receive the service. The user may turn off her receiver 301 at any time. After the user has received the service, the receiver 301 is turned off. The user device 301 is turned on again t_RA2 at the next signalling time-slot t_SA2. In time-slot t_SA2 the user terminal may receive information that another service, SERVICE 2, is going on at present. The user receives a notification on that and may turn her receiving device on. As with the SERVICE 1, the user may have programmed her receiving device to turn on, whenever SERVICE 2 is available. Within the broadcasted stream some of the broadcasted services may be multiplexed i.e. comprise more than one service as illustrated in the diagram with SERVICE n and SERVICE m within the same transmitting time period.

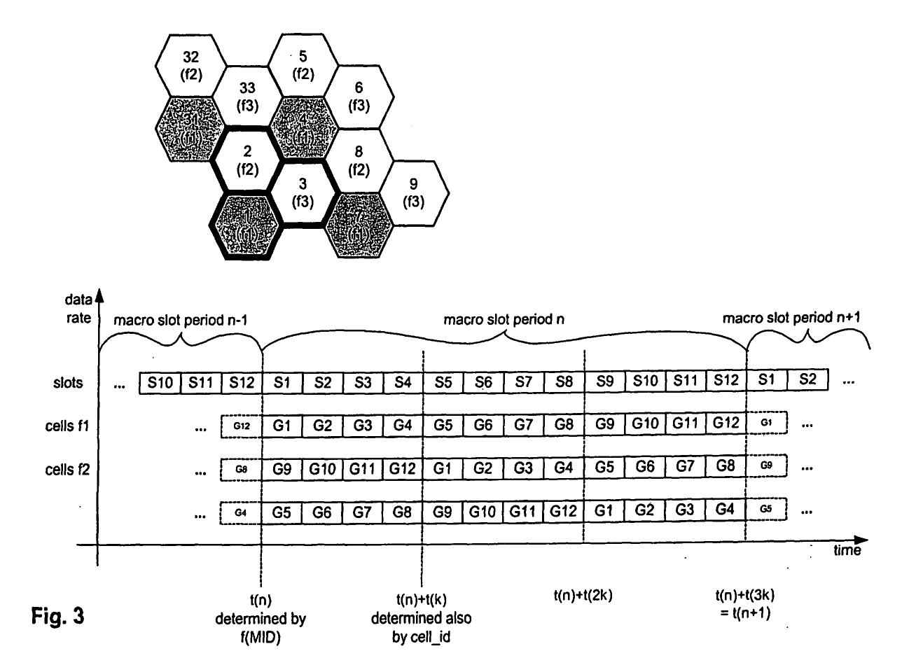

In FIG. 3 the use of the cell identification (cell_id) in the hash function is shown. When the cell identification is used in the hash function, it may enable slots to be timed also according to the cell they are in. In FIG. 3 the cells are numbered with cell_ids 1 . . . 33 and a reuse pattern of 3 frequencies (only as an example). If the hash in this embodiment were [hash=f(MID)+(k*modulus(cell_id/reuse_number], e.g. [reuse=3, k=4] then 12 slots would be easy to configure as non-overlapping between neighbouring cells. The essence of anti-synchronous slicing is exactly that—sending the same data in a coordinated way so that neighbouring cells do not send the same service at the same time. The simple cellids in FIG. 3 are only one example. Using either existing (standardized) cell ids or cell_ids which are a “logical overlay” mapping to physical cell id's are within the scope of this embodiment of the invention.

So the general “use of cell id” in calculating hash (result of hash function) is to be protected and so is the case where this is used in anti-synchronous slicing (subclaim).

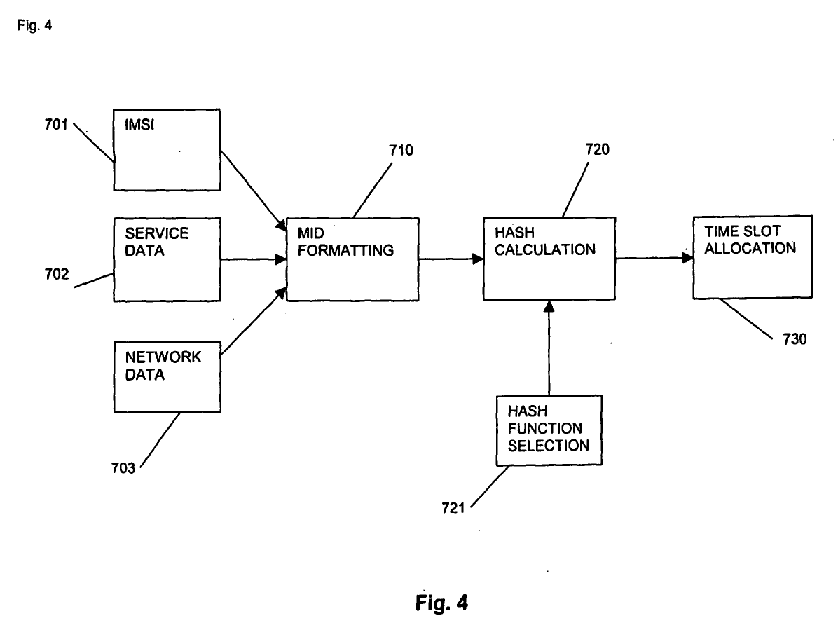

In FIG. 4 the process in server or network side for forming the MID and mapping it to a time slot is shown as a flow diagram. The MID is created in step 710 from one or more data items, such as IMSI of the user device 701, data relating to the service 702, data relating to the network parameters 703. The MID is created preferably at the broadcaster or at the network service provider. The creator of the MID selects 721 the hash function and performs the hash function calculation 720. The calculated hash is then mapped 730 to the time slot corresponding to the hash value. The data items used for creating the MID are given as examples.

In one embodiment the formatting of the MID 710 may comprise hash calculation 720, wherein these two steps are combined into one.

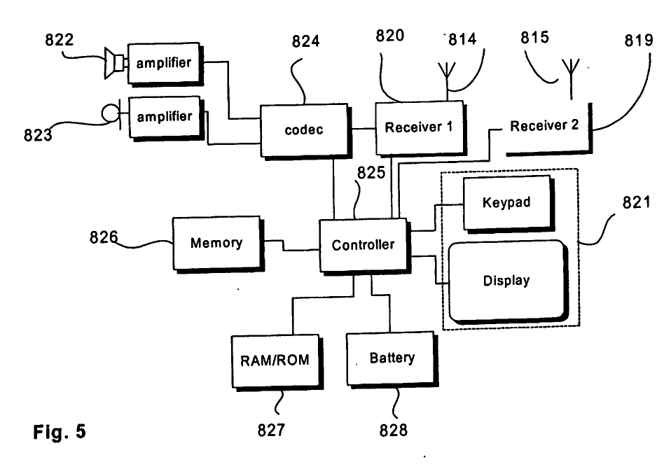

The user device 800 as shown in FIG. 5 receives incoming transmissions using one or more antennae 814, 815 one or more receivers 819, 820. For example, multiple antennae 814 and receivers 815 would be needed where the first and second communication network utilise different radio technologies. The receiver 820 may used for receiving broadcasted services including and/or excluding notifications like SI information and the receiver 819 may be transceiver for receiving notifications in the signalling channel and for other communication like bi-directional services. The user device further comprises a user interface 821, with a keypad and display, a speaker 822, a microphone 823 and codec 824. The operation of the user device 800 is controlled by a controller 825, which has associated memory facilities 826, 827. The user device 800 is powered by a battery 828. The controller 825 is configured to receive notifications from the signalling channel and based on the received notifications, the controller 825 enables receiver 820 to receive broadcast transmissions. The user may control the operation of the user device with the user interface 821.

The notification transmitted in the time slot may comprise the MID itself, a notification of a data transmission (imminent, in-progress, or waiting), a service announcement, e.g. SDP, SAP, UDP/IP, RRC. DVB systems might include a reasonably large (several hundred bytes to several kilobytes) service announcement data which could give session parameters (e.g. start and stop time, protocols used, ports and IP addresses, etc.) and content details (artist/author, owner, parental rating, price, etc.) for one or more sessions. UMTS systems are likely to be more conservative as the channel allocation system is different. So a UMTS service announcement in accordance with the invention might identify the service (MID and/or session_id and/or destination IP address and/or source IP addresses and/or ports) and give just the minimum of extra information (e.g. will start in 20 seconds, or will start at 09:33:00 GMT+2, has been cancelled, or tune to an announced channel for a full service announcement, or go to this URL for a full service announcement or description).

The term “notification” is meant to indicate an access network specific “announcement” (e.g. using paging mechanism of 3G, or TS adaptation field of DVB-T) which contains a small amount of data. The notification differs from “service announcement” in that generally the latter is seen directly by the applications and can be non-access network specific (e.g. the use of SDP over IP to describe services, timing, IP parameters, etc.).

In 3G, terminals in idle mode are notified of incoming data using the paging mechanism that prompts them to go to connected state, i.e. to activate the dedicated radio resources, and receive the data. The exact same protocols and information elements can be used in one embodiment without the need to then set up a dedicated connection. However, that is only one alternative embodiment. The use of such a MID, which may not be in the same format as the IMSI, the use of alternative logical, transport and/or physical channels to the PCH (paging channel) and the use on other access networks e.g. DVB-T and also with other network mechanisms such as e.g. DVB-SI tables can all be different embodiments of the invention.

Data in the simplest notification would be “current MID” indicating only the service of which MID is currently being transmitted. “Current and next MID” is slightly more advanced. These are suitable where the data transmission channel is incapable of multiplexing and scheduling is almost non-existent, i.e. there will only be packets of one service on the air at a time and many of the same will be delivered in a row.

Where data is buffered in advance, which relates to scheduling and the channel can deliver more than one service at a time, more data is needed. For instance, each time slot given by the hash can give a list of MIDs which are currently or about to be active so that terminals wanting these services know to wake immediately. Also, when in one embodiment timing data is added to the notification e.g. a specific MID in 30 seconds, more exact timing of the wake-up can be achieved while allowing for multiple notifications before actual transmission, e.g. in case when link errors prevent some of these from being successfully received. It is also possible to list all the known MIDs of existing services and indicate which are active, about to be active, inactive or cancelled. This embodiment is, however, not scalable to large numbers of services and may thus be used in special situations.

MID can be of any format e.g. a 32 bit field indicating an IPv4 address including the same as IMSI. The use of MID is different from the prior art use of IMSI, particularly as IMSI is for one specific user and paging with it or a temporary IMSI requires the set up of a bi-directional communications channel to transfer the data.

In one embodiment for Source Specific Multicast (SSM) MID is calculated from IP source and destination addresses and is the same length as a standard 3G IMSI, i.e. MID[16 bits]=f(IP_source_address[32/128 bits], IP_destination_address[32/128 bits]), where 32/128 bits depends on the use of IPv4/IPv6 addressing respectively. Similar embodiments may rationalize the IP addressing input to this calculation further. For example, only using the 64 least significant IPv6 address bits where the 64 most significant bits are common to all destinations in the relevant network, as could be the case for a common prefix and/or scope.

The user device UE may listen for its IMSI notifications and for broadcast and/or multicast notifications.

The UE may be listening to both individual and group notifications on the same channel and on different channels.

In one embodiment the UE is operating exactly as in dedicated paging and listening to the same information from the same channel or on a different channel, but does not set up a dedicated channel. In another embodiment group signalling on the uplink may be provided, e.g. a special 3G/RRC message or an IGMP to join. In one embodiment it is preferred that these actions, e.g. joining to a group, have taken place before starting to wait for notifications).

Once a UE is “paged” with a MID, which it was interested in to wake up for, in one embodiment the UE may open an other notification channel which contains more information about services related to that MID, e.g. the terminal device starts listening to all service announcements specific for imminent services. In another embodiment the UE may open a data channel and the UE then expects to start receiving the service immediately or quite subsequently.

In one embodiment the MID can be used to signal incoming data packets on UMTS multicast/broadcast radio links. A similar method as in 3G point-to-point can be used for multicast. The multicast service id (e.g. session id, destination IP address, or any similar identification) can be used as a MID. Thus a UE, which has joined, registered, or subscribed to one or more multicast feeds will wake up also at the time slots of the multicast feeds to see whether it should listen to another channel for multicast data. The other channel in 3G could be some existing (e.g. FACH) or a new defined channel (e.g. dedicated multicast channel). Also in some embodiments of the invention the MID should be repeated to ensure that it is received even if some slots are corrupted through, e.g., interference, or when a UE joins a service half way through, it can also learn which channel to find it on. The MID slot may also comprise information as to when the multicast feed will be sent and for how long time (e.g. in 30 seconds for 10 seconds duration). This method can also be used for unidirectional unicast (p-t-p) services where the UE knows when to use the data channel without having to set-up a dedicated channel—the benefit is reduced signalling.

In another embodiment the MID can be used to signal incoming data packets on broadcast radio networks (e.g. DVB-T), wherein in DVB this identification can be used in a known channel (e.g. predefined PID). This could fit into a general “slotted” scheme for the radio channel (i.e. where time slicing is used) or could be used where only this technique is slotted and the user data comes in the “traditional” continuous fashion. The invention allies equally to unicast, multicast and broadcast, as well as unidirectional and bi-directional services.

The MID can be used to time the service announcements (e.g. SDP, SAP, or UDP/IP), notifications of feed (e.g. paging, DVB-SI) or even user data (e.g. video stream, file transfer).

Further the MID can be used as an identification for a temporary multicast group like e.g. temporary mobile subscriber identity is used also for other applications. Such applications can be mapping the radio access specific notifications to the IP-generic service announcements. The use of MID is not restricted to signalling using time-slots.

When the slotted item is a service announcement or notification, it may be only part of a “service discovery hierarchy” (where other techniques can be used in combination to get full “service discovery data”). E.g. an SDP service directory, or just the layer 1,2,3 parts of a separate SDP message.

The MID may be notified to the UEs implicitly or explicitly. A shared algorithm or calculation, which is based on other data is implicit—e.g. from an earlier service announcement or request-response, the UE discovered the relevant ALC channels and/or IP addresses and UDP ports for a filecast. It then uses the same hash function as the network does to calculate the MID. A service announcement can contain the MID decided by the network or service system and explicitly tell the UE of it. The UE may be required to do a duplex (bidirectional, request/response) exchange to discover the MID explicitly. This could be at one or more network layers and involve one or more network subsystems, but in one embodiment the UE sends a 3G specific message to retrieve the MID for one or more specific sessions to RNC or SGSN or GGSN or BM-SC or P/I/S-CSCF, wherein the request identifies the one or more sessions. In another embodiment the UE uses HTTP/TCP/IP and in another further embodiment WAP to request the service description from a service directory server, wherein this description includes the MID.

Although the use of destination IP address also known as ASM (Any Source Multicast) group and IP source and destination addresses also known as SSM (Source Specific Multicast) channel, and session_id (generic, but may be taken from SAP) has been used in many of the examples, it is possible that multiple MID are associated with any of these (e.g. MIDs map one-to-one to ACL objects, and in turn these map many-to-one to ACL sessions, ACL channels and the associated ASM/SSM group/channel).

Different id's could be used to replace the IMSI as a “virtual identification”. In the background of the invention are given examples of different multicast identifiers—e.g. SDP session id, which could be equally well used for provided that this identifier is available to network and UE.

The hash function may be based on a unique identifier of each UE—the IMSI (International Mobile Subscriber Identity). For example, the last 8 bits of the IMSI can be used to identify 256 slots. It may be noted that it is also possible to use the P-TMSI (Packet-Temporary Mobile Subscriber Identity) of UEs where this has been temporarily assigned for security reasons. Whereas the use of IMSI to calculate the slots for dedicated communication channels is prior art in 3G, the combination of several IMSIs of some user group members or the “virtual” MID IMSI is novel. As is the use in point-to-point unidirectional broadcast networks such as DVB-T.

Furthermore, various hash functions can be used. A simple example is to take the last 8 bits of the selected identifier to calculate directly which of 256 slots are relevant (e.g. Ipv4 address 240.100.200.131 would indicate slot 131)—this has the advantage of simplicity in processing. However identifiers may be correlated (e.g. 2-50 may be used on most subsets and 51-255 on very few), so that some slots are populated by many more UEs than others. This may be avoided by selecting a hash function which leads to an equal distribution of UEs in each slot.

An implication of this invention is that the UE and network would need to be synchronised in time or slot “location” for the hash calculations to be used. There are many methods to do this, such as e.g. relative and absolute timing, but they are out of scope of this disclosure. In relative timing the UE knows the time relative to the network so the network could announce “in 30 seconds from now”. In absolute tiring both network and UE know the absolute clock time so that the network can announce “at 11:37:00” (hh:mrss). The clock may be global (e.g. GMT+2 hours) or network-local (e.g. the network's time which may be fast or slow).

When used in a time-slicing network, where different cells are anti-synchronized, in one embodiment of this invention the slot time calculation, such as the predefined hash function, can include also some “cell identifier” as well as IMSI and/or MID. Thus a UE could listen to certain MID notifications from multiple cells using the same radio front-end as they do not occur simultaneously on neighbouring cells.

The “cell identifier” is relevant to the physical network topology (geography) for time slicing more than the logical numbering of cells.

The disclosure above focuses on the case where, after a paging-like signalling, the UEs do not signal the network. The invention is, however, not restricted to that situation. The UEs may respond with a “request bearer” messaging similar to normal 3G for unicast and a new idea for multicast, or the UEs respond with an IP (e.g. IGMP,Internet Group Management Protocol) messaging where they could join an IP multicast group or report their status.

The disclosure of the invention describes in general PS (packet switched) systems, but the invention is not restricted to such systems but the embodiments of the invention can equally be applied to CS (circuit switched) systems and hybrid PS+CS systems.

The invention is applicable for IP Datacast systems (DVB-T based, etc.) and 3GPP Multimedia Broadcast Multicast Service (MBMS).

Furthermore, since numerous modifications and variations will readily occur to those skilled in the art, it is not desired that the present invention be limited to the exact construction and operation illustrated and described herein, and accordingly, all suitable modifications and equivalents which may be resorted to are intended to fall within the scope of the claims.

1. A method of creating signalling information relating to one or more available services in a network, the method comprising the steps of:
defining a service-indicator-fox one or-more of the services;
formulating the service indicator into a unique indicator having a predetermined format;
mapping the unique indicator into one time-slot of a signalling channel.

2. The method of claim 1, wherein the service indicator defining step includes one or more of the following:
using at least one service identifier relating to the one or more services;
using one or more identification data items for each of the selected services;
using one or more data items identifying at least one user terminal having access to the broadcast network; and/or
using one or more data items relating to transmission parameters of said network.

3. The method of claim 1, wherein the formulating step comprises:
selecting a hash value calculation scheme; and
calculating a hash value for the service indicator.

4. The method of claim 1, wherein the mapping step comprises:
selecting a hash value calculation scheme; and
calculating a hash value for the unique indicator.

5. The method of claim 1, further comprising:
creating a notification relating to said selected service, and transmitting the notification during the time-slot.

6. The method of claim 5, wherein the notification comprises identification of one or more channels of the broadcast network transmitting the selected service.

7. The method of claim 2, wherein the data item identifying said at least one user terminal is an International Mobile Subscriber Identity.

8. The method of claim 2, wherein the data item relating to the transmission parameters of the network is an identification for a network cell.

9. The method according to claim 1, wherein the network is a broadcasting network.

10. A communications device comprising:
first receiving means for receiving broadcast transmissions comprising one or more services;
second receiving means for receiving signalling information on a signalling channel;
means for controlling the first receiving means, wherein the first receiving means is enabled for receiving one or more services in the broadcast transmission upon received signalling information relating to said one or more services by the second receiving means.

11. The communications device according to claim 10, wherein the second receiving means for receiving signalling information is enabled to receive signalling information in a signalling channel during a specified time-slot.

12. The communications device according to claim 10, wherein the second receiving means for receiving signalling information is enabled periodically to receive signalling information in a signalling channel during a time-slot.

13. The communications device according to claims 10, further comprising means for generating an indication of the occurrence of the said time slot.
